(19) United States
(12) Patent Application Publication
(10) Pub. No.: US 2017/0116694 A1
(43) Pub. Date: Apr. 27, 2017

(54) SYSTEM AND METHOD FOR MONITORING A DIGITAL WORK

(71) Applicant: SoundVault Limited, Reading (GB)

(72) Inventors: Graham GABIE, Harrow (GB); Alastair TELFORD, Canterbury (GB)

(21) Appl. No.: 15/332,293

(22) Filed: Oct. 24, 2016

(30) Foreign Application Priority Data
Oct. 23, 2015 (GB) 1518854.3

(51) Int. Cl. G06Q 50/18; G06F 17/30

(52) U.S. Cl. CPC G06Q 50/188; G06F 17/30424; G06Q 2220/123; G06Q 2220/18

(57) ABSTRACT

The invention relates to a method and system for monitoring an original work, such as a digital work, and provides a reporting and auditing service for example for monitoring and deriving a royalty payment in favour of a rights owner.

A unique identifier for a digital work is established. The work is typically stored on, and retrievable from, a database. The work is typically transmitted in a digital format from a subscriber who asserts ownership of the work and that the work is an original work. A categorisation of the work is then performed to provide at least one form of category data in accordance with at least one criterion The category data is included in an indicia associated with the work and an indicia includes a time and date stamp of receipt of the work from the subscriber.

The system operates to compare the work with content of third party databases in order to determine whether the work matches any content of a third party database and provides a clearance certificate when no matches are indicated. The system also generates a root identifier which associates both the indicia and the clearance certificate with the work so that future use of the work, by a third party is monitored in order to report usage to the subscriber and/or rights owner.

### FIELD

The invention relates to a system and method for monitoring an original work, such as a digital work, and for providing a report, in particular, but not exclusively, a usage report for the purposes of deriving a royalty payment in favour of one or more beneficiaries or rights owners.

### BACKGROUND

The UK is the second largest music exporter in the world. The performing rights society (PRS) reported a 45.3% rise in digital services revenue in 2012. Currently composers and rights owners receive around 50% of the fee a buyer pays for the right to use the music which is known as the synchronisation revenue. Composers then retain around 50% of performance royalties which are royalties paid each time a composition is played to an audience.

Music excerpts, songs, lyrics and recordings are used in a number of media applications, such as advertisements, films, video games and trailers for films. Sometimes, when producing a new item of media, an organisation, such as film studio or other production company, might wish to include some music to suit a scene or create a mood. Usually this is achieved by way of licensing a piece of existing or specially created digital material. This material may include: songs, lyrics and recordings which are usually stored in a machine readable form.

The music (work) may be stored on a recorded medium, such as a gramophone record, an audio tape, a compact disc or in a digital archive or held at another source.

When such music or music excerpts are used, composers, record companies, songwriters or music archive owners often claim a royalty for that use. The amount of royalty may depend upon many variables, which include: the amount of usage of the musical work, the extent of global usage of the work, how the work is used, whether the musical work is included in a movie (feature film), if its use includes television or radio broadcasts; if the work is included in a video game; if the work is used in advertising, as well as a myriad other digital and online applications, including software applications (‘APPS’).

Seeking permission of the rights owner; obtaining the piece of music in respect of which a royalty is due; determining the nature and extent of usage of the music and calculating royalties owing based on the nature and number of plays is currently inefficient, fragmented and attracts high commission fees.

Composers and rights owners therefore sometimes suffer losses or a dilution of their rights and are usually unable or inhibited from keeping track of their royalties, especially as the Internet enables digital versions of films and games to be performed with relative ease.

In addition music buyers suffer from multiple small libraries, poorly tagged musical works, complex and/or slow licensing processes; complicated pricing policies and inefficient digital cue sheet reporting.

A cue sheet is an electronic record, which may be in the format of a database system, with fields that are populated and used by the industry, to monitor usage of a work and ensure correct royalties are paid to the rights owner.

### PRIOR ART

US Patent Application US2009/020220 (Amnon Sang) discloses a method for enabling automatic creation of a cue sheet for reporting of digital assets used in production. The method begins by parsing an edit decision list, having codes containing a digital asset file, and the duration of time that the file was used in a production process. The method also includes using the codes as a key for searching a database of rights' owners so enabling information needed to create a legal cue sheet for reporting of the digital assets.

U.S. Pat. No. 8,521,779 (Adelphoi Limited) discloses a computer implemented method and system providing automatic selection and extraction of metadata and media content from projects in a craft tool. Automated identification, classification and management of such metadata and content is provided using techniques such as pattern recognition for audio and visual content. An automatic tracking and storage facility of metadata and content for compliance purposes is also disclosed.

Many digital archive companies do not provide any automated services and have a complicated royalty rate card negotiated via local collection societies. These systems are outdated and cumbersome for users. They rely on cue sheets. It is believed that currently the cue-sheet system is inaccurate and does not serve the needs of its users; as often artists are not properly paid royalties they are due.

One aim of the invention is to provide a platform for digital data, in particular digital data relating to sound or audio data, for use in identifying a particular piece of music.

Another aim of the present invention is to provide a system for monitoring licensing and royalty payment process, in which all parties involved in a value chain are included.

### SUMMARY OF THE INVENTION

According to a first aspect of the present invention there is a method for providing a unique identifier for a digital work, the work being stored on, and retrievable from, a database, the method includes the steps of: receiving a file of a work in a machine readable format from a subscriber who asserts that the work is an original work; comparing the work with content of third party databases in order to determine whether the work matches any content of a third party database and providing a clearance certificate when no matches are indicated; categorising the work to provide category data in accordance with at least one criterion and incorporating the category data in the form of an indicia, the indicia includes a time and date stamp of receipt of the work from the subscriber; and providing a root identifier which associates the indicia and the clearance certificate with the work so that future use of the work by a third party is monitored in order to report usage to the subscriber and/or rights owner.

The invention assists with and enables the automatic collection and distribution of license fees—that are due for the right to use the music.

According to a second aspect of the invention a system provides a unique identifier for a digital work, the system is operative to retrieve the work from, and transmit the work to, a database whereat the work is stored, the system comprises: an input port for receiving a file of the work in a machine readable format from a subscriber who asserts that the work is an original work; a comparator that is operative to compare the work with content of third party databases in order to assess whether the work matches a significant proportion of an existing work stored at a third party database the comparator provides a clearance certificate when no matches are indicated; a categoriser which is operative to categorise the work in order to provide category data in accordance with at least one of a plurality of criteria, the category data including an indicia which affirms a time and date stamp of receipt of the work from the subscriber; and an identifier provides a root identifier which associates both the indicia and the clearance certificate with the work, so that future use of the work by a third party is monitored in order to report usage to the subscriber and/or a rights owner.

The system also provides a copyright labelling, monitoring and management capability as well as a royalty tracking system that is available and accessible to users or stakeholders in a value chain for authentic works.

The system therefore reduces costs for media producers and is beneficial to rights owners, not only because it tracks works, but also ascertains whether works are themselves copies of earlier works, in which cases an alert issued and the work is rejected for including in a database.

Ideally a work is selected from the group comprising: digital music files, digital video files, digital image files and digital text files.

Territory sensitive licensing is able to be achieved by way of a geo blocking option that enables the system to automate and consolidate an entire value-chain by providing composers an “end-to-end” solution and enabling them to create their own online library, upload their own choice of music and to promote, license and distribute their own music, in the knowledge that a rights owner is being recognised and, where necessary, is also paid a royalty.

Preferably a work includes digital data. Ideally a unique categorisation index is updated according to user access data.

Advantageously a buyer is able to select at least one criterion from the group comprising: tempo, genre, keywords, classifiers or beats per minute (BPM).

Ideally the method includes the step of providing a digital signature to a rights owner or defined beneficiary. This helps to ensure that a digital cue sheet, for an audit trail of a work, is accurate and always up-to-date. In accordance with an algorithm usage and distribution of works is reported to one or more predefined users.

The digital cue sheet ideally is in the form of a tag which includes at least the following fields: data relating to the rights owner, data relating to an performer and/or composer, the unique identifier, data relating to the subscriber, the tag which includes category data and the time and date stamp of receipt of the work from the subscriber, the clearance certificate number and the root identifier.

An editable version of the digital cue sheet is typically populated with at least the following user specified tag fields: data relating to a user. Additionally, data relating to a prospective licensee may be included as well as, for example: data relating to an actual licensee; and/or data relating to details of a license, whose terms may vary according to territories and/or usage; data relating to a royalty sharing agreements with third parties, such as manufacturers.

Optionally input of data to the system, such as music files and associated meta-data, is partitioned from a so called application layer (which is ideally suited for searching and for licensing) so that music data can be added to a database independently of indexing.

In addition to the forgoing, data relating to the name of one or more recipients of a royalty payment may be included as well as data relating to an organisation overseeing royalty payments, such as the performing rights society (PRS) in the UK.

Additionally data relating to a royalty recipient's bank account, which may be an ESCROW account, may be uploaded and stored. Other relevant data includes: author related data, composer related data, performer related data, publisher related data, and data relating to a rights owner and data concerning royalty sharing arrangements.

Preferably a negotiation platform or market is included for enabling a deal to be brokered between at least two of the following: a buyer or buyer's agent, and a rights owner or their agent.

The system provides a communication and arbitration platform between all parties, enabling rectification of licensing inaccuracies and verification processes. The system provides for the possibility of arbitration, for example in the event of disputes, so that all licensing parties are assisted in reaching agreement.

Advantageously a unique digital identification (ID) and Internet uniform resource locator (URL) enable digital cue sheets to be accessible and retrievable by authorised parties, such as licensing parties, production companies, broadcasters, collecting societies, right's owners and prospective re-licensors.

Optionally a digital cue sheet includes: licensing data and live tracking of broadcasts from transmission stations as well as what digital, terrestrial or online channels are broadcasting.

The present invention therefore ensures composers benefit from their efforts by receiving a greater share of their royalties via a music-usage-tracking-system and it enables composers to review and verify music usage reports.

It is appreciated that the present invention may be used with live music and other forms of digitized data. The so called ‘sync licensing’ is a rapidly expanding music industry segment. Estimated growth for internet protocol television (IPTV) in the UK alone is 50% between 2015 and 2020.

The present invention has a metadata framework which enables it to offer an advanced end-to-end music-licensing platform, creating a non-exclusive bridge between the composers, music licensors, music licensees and the overseeing of royalty payments.

Ideally, in one embodiment the system employs an archive of at least 3 000 000 digital music tracks through a portal via existing partnerships with libraries.

Optionally a method of selecting a genre or use, with desired features, includes a weighting function to assign two or more user selected criteria. Ideally the weighting function assigns a weighting factor in accordance with a predefined categorisation index. Alternatively a user may search fields in the tag.

Preferably expressions that are common to film directors, film producers, sound engineers and script writers are employed and linked using metadata. These keyword expressions are derived from word categories related to: emotion, mood, clarity, texture and motion.

Advantageously the system employs genres and word uses (synonyms) which are preferably weighted according to the type and nature of music so that digital files are categorised using genre keywords and expressions. This facilitates categorisation and searching according to musical attributes by way of descriptive metadata that is associated with specific recordings or artists or albums. This enables a wide range of suitable linguistics terms to be used, for example when searching for a suitable piece of music.

Ideally a database is capable of searching fields that include at least one of the following: a user or subscriber specified query and/or a user or subscriber specified category query and/or a user or subscriber specified criterion query and/or a user or subscriber specified rights owner query.

The invention therefore provides an automated uploading, promotion, licensing and distribution of licensing and royalty fees for each individual track. Additionally it enables users to edit and manage files online and in real time.

Optionally the present invention also enables a search and recommendation process in the form of one or more algorithms. The at least one algorithm draws together user and/or subscriber search criterion with playlist matches created by other users of the system, and weighting criterion. An advantage of this is immediate and greatly reduces the amount of time that composers spend creating metadata and uploading music, and so rapidly increases the pace of music ingestion.

The present invention also provides a user-generated education platform for diverse communities and so encourages students and semi-professional musicians and composers to engage due to the removal of historical ‘high barriers’ to entry.

A preferred embodiment of the invention will now be described, with reference to the Figures in which:

### BRIEF DESCRIPTION OF THE FIGURES

FIG. 1 shows an overview of a system for overseeing music licensing;

FIG. 2 shows a diagrammatic overview of a system for overseeing music licensing;

FIG. 3 shows a more detailed overview of a system that oversees music licensing and cue sheet creation and verification process;

FIG. 4 shows an overview of the system that oversees and manages track upload process and track duplication checking;

FIG. 5 shows an overview of Global Synchronization Platform repository usage and verification of different parties that interact with the system;

FIG. 6 shows an overview of one example of a verification, reporting and payment collection process that is employed in the system;

FIG. 7 shows a system overview illustrating diagrammatically how the invention improves searching and selection of tracks;

FIG. 8 is a system overview that illustrates diagrammatically a connection between a licensee and a user (buyer) when using cue sheets and shows a payment triggering event;

FIG. 9 is a system overview that illustrates performance usage tracking;

FIG. 10 is a system overview that illustrates the licensing and cue sheet creation process and illustrates an overview of cue sheet collection process, by broadcasters, as well as onward delivery and reporting processes;

FIG. 11 shows a system overview of the cues sheet, creation, delivery, reporting and verification process;

FIG. 12 is a flow diagram illustrating an example of the operation of the host system to create a cue sheet;

FIG. 13 is a flow diagram illustrating an example of the operation of the host system to import files; and match music and metadata with existing data, or to generate new metadata; and

FIG. 14 is a flow diagram illustrating an example of the operation of the host system to license and re-license files.

### DETAILED DESCRIPTION OF PREFERRED EMBODIMENTS OF THE INVENTION

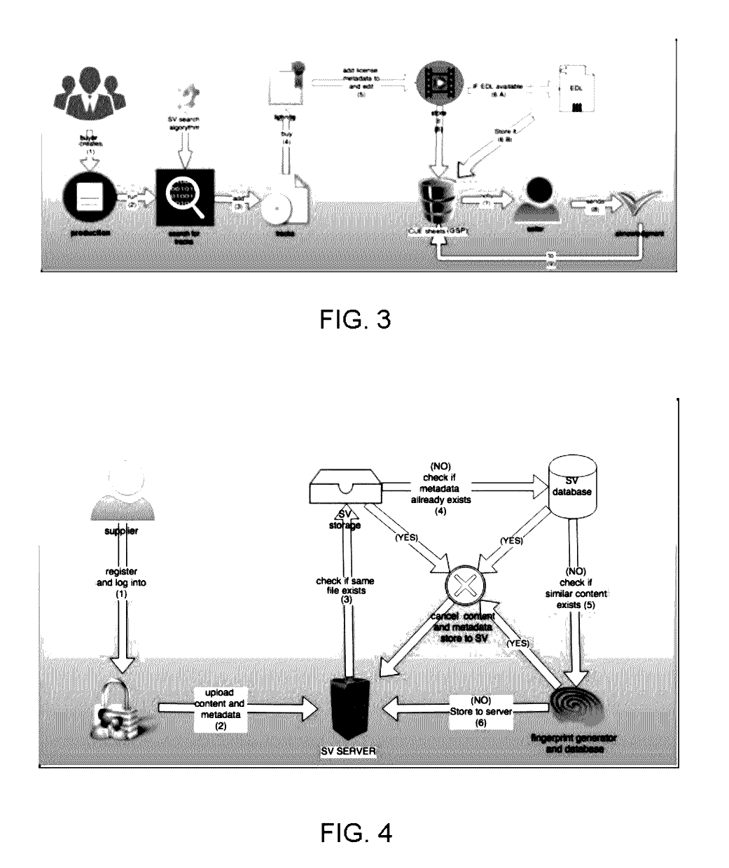

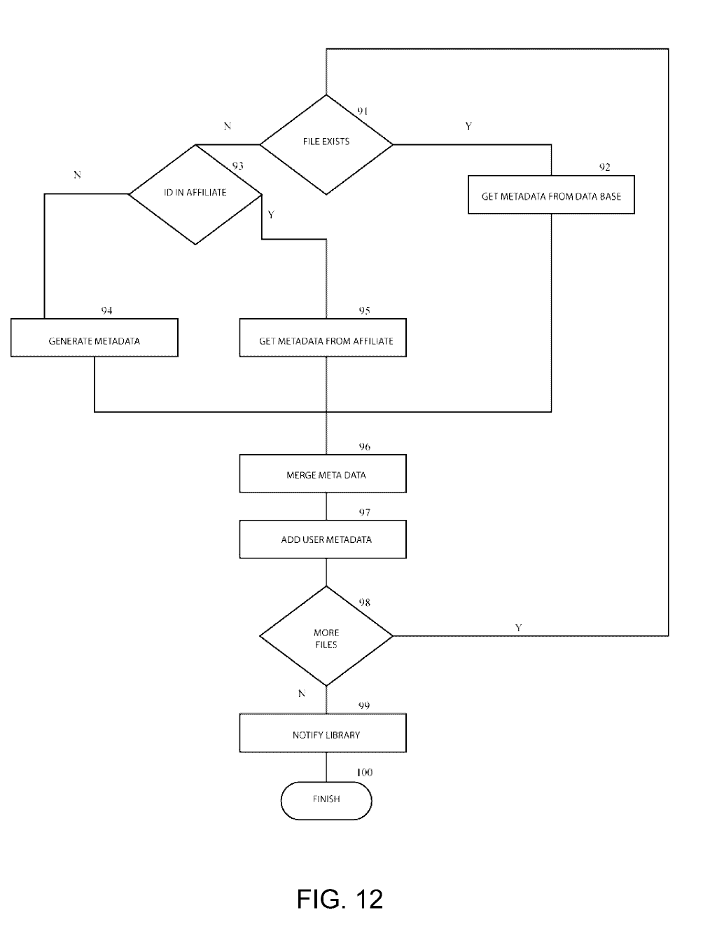

Referring to the Figures generally, and in particular FIGS. 3 and 12, there is shown a global synchronisation platform (GSP) which stores files and associated ownership metadata and file qualitative and quantitative metadata, allows buyers to create a production (FIG. 3 step 1) search for files on the system (FIG. 3 step 2), license files according to specific licensing parameters (FIG. 3 step 4), generate cue sheet (FIG. 3 step 6, 6a, 6b) recording actual content usage and associated metadata for onward reporting (FIG. 12 step 91-98), and notify licensors (FIG. 3 step 7) so that they may verify the accuracy of cue sheet/usage reporting (FIG. 3 step 8 & 9).

Buyers and suppliers may be differentiated at login and in use are directed to different interfaces and tool sets. It therefore follows that a buyer will need to use different login details if they would like to set up a library on the system and become a supplier, and vice versa. A buyer can license music or content for use in their creations. A supplier who may be a subscriber can create their own unique library, upload their music or files, and set the licensing terms of the said files. In an alternative embodiment buyers may also be sellers.

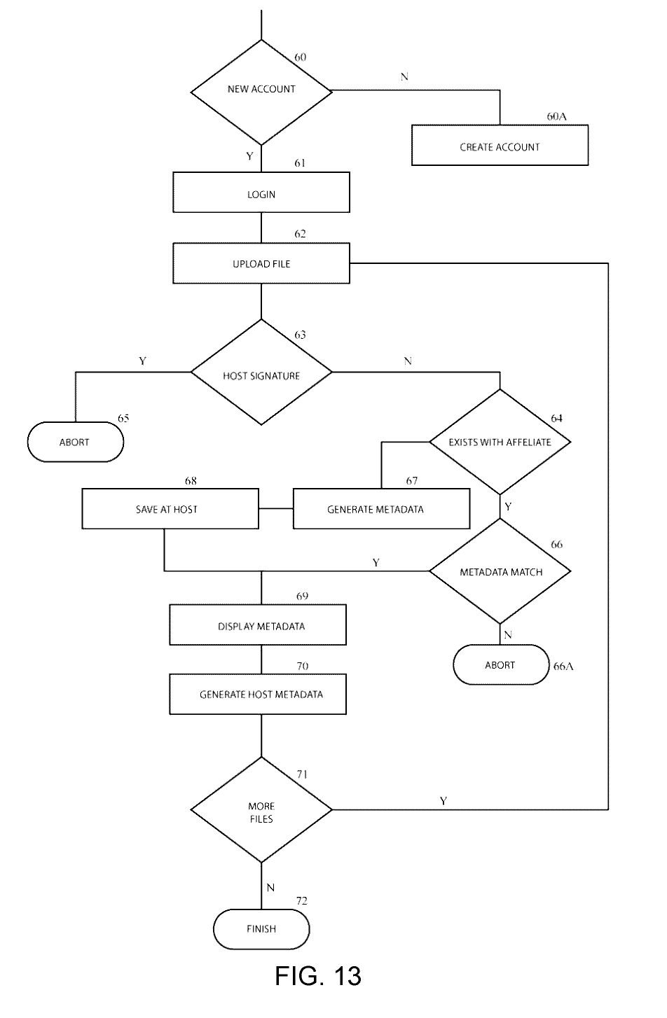

FIGS. 4 and 13 depict key stages in a method that provides a unique identifier for a digital work. The work is stored on, and retrievable from, the host system along with ownership metadata (including multiple ownership and publishing rights and third party tagging information), and file qualitative and quantitative metadata. The method includes the steps of: receiving a file of a work in a machine readable format, such as a digital WAV (Trade Mark) file format, from a subscriber who asserts that the work is an original work. The system then categorises the file to provide category data in accordance with at least one criterion, including or embedding this category data in the form of an indicia in the digital file.

The indicia includes: a time and date stamp of receipt of the work from the subscriber. The system then compares the work with content of third party databases in order to determine whether the work matches any content of any third party database. If the work does not match anything that is stored on a third party database a clearance certificate indicates that no matches are found. The system then provides a root identifier which associates both the indicia and the clearance certificate with the digital work so that future use of the work by a third party is monitored in order to report usage to the subscriber and/or rights owner.

FIGS. 4 and 13 depict files being imported into the metadata framework culminating with a unique registration and identifier that not only identifies the work and alternative ID Tags for the work but also multiple rights on a territory by territory basis associated with the work and its derivatives. When a file is imported it is verified, such that the supplier of the work is able to offer it confidently without risk of it being a copy of an earlier work. If, when a work is imported a risk of any rights infringement is identified, a block or warning is issued and the system refused to upload or recognise the work. Likewise a licensee is able to acquire a work with confidence that it does not infringe another party's copyright.

FIG. 4 shows an overview of a system that imports files into the database. The supplier registers an account and logs onto the system (step 1) in order to upload the file and associated ownership metadata to the database (step 2). When the file is imported, the system checks if an identical file exists in the database (step 3), if the file being uploaded is a duplicate the process is aborted and no import is made to the database. If the file is not a duplicate, the system checks if a duplicate of the file metadata exists in the database (step 4), if duplicate metadata does exist the process is aborted and no import is made. If no duplicate metadata exists the system checks if similar content exists and creates a unique identifier and finger print for the digital file.

Checking of unique identity of works and ID Tags, as well as date, time and optionally location of generation of the work; as well as acquisition time and date, may be integrated as part of the host system or can be separate therefrom (step 5). If the process in step 5 is aborted no import is made.

If the system acquires the necessary fingerprint (step 6), the finger print and file are stored in the metadata framework along with other all other related metadata including additional associated ID tags, such as Google ID (Trade Mark) and alternative signatures on the server.

An outsourced digital “fingerprinting” or digital signature service or affiliate system is used to verify authenticity. Examples of such digital signature services for music tracks include Echonest (Trade Mark), Gracenotes (Trade Mark) and Shazam (Trade Mark). All third party authenticity tools are recorded in the metadata framework. This also allows for multiple or alternative publishing rights for the same piece of content. The invention enables right holders to hold all ownership data in one location and utilises alternative broadcaster platforms and affiliated monitoring tools to manage output.

If a digital file is verified as unique (that it is not a copy or duplicate of another work) the system firstly introduces a time-stamp associated with the work as an identifier. This effectively registers and legitimises the work and its claimed rights ownership. Therefore this step creates a detailed record of rights ownership, writer and publisher as well as a record of any royalty sharing arrangement.

An authenticity check therefore compares a newly presented work, using open source software, which enables a comparison to be made currently with databases of more than 60 million existing tracks. This is considered an important part of the invention as it mitigates risk of copyright infringement by virtue of the fact that a work is rejected (or labelled as questionable) if a significant portion is matched with an existing work.

The system allows the uploading of multiple files and the editing of their metadata. It incorporates an automatic step of deriving metadata from musical tracks and the ability to add and/or edit metadata for each track. This process obtains quantitative musical attributes, including such metadata as beats per minute, opening and closing key, major/minor, root tonic and instrumentation. Basic qualitative attributes are recorded, for example as “bright”, such that expressions or mood can be derived by using keywords or synonyms. A look-up table of words and synonyms provides a glossary of industry keywords for indexing and retrieving analogous themes.

During the upload process a digital work (such as a piece of digitized music) is examined to check for copyright infringement. Further mitigation is provided by a ‘user flagging’ capability. This is where users are asked to rate the accuracy of the music metadata, and the quality of the music, and whether users wish to create and share playlists of related music.

FIG. 13 is a flow diagram illustrating an example of the operation of a host system to upload files. Library (uploader) creates a new account 60A or logs into an existing account 61 in order to upload a file 62 to the host system. A module 63 checks if the file signature exists within the host system. A duplicate signature is treated as a duplicate file and the import process is aborted 65.

If a signature file does not exist within the host system a module 64 checks if the file's signature exists within an affiliate system. If the signature of a file exists within an affiliate system, another module 66 checks if the ownership metadata of the file that is being uploaded, matches the metadata of the file with the matching signature on the affiliate system. If the ownership metadata does not match the upload process is aborted 66A.

If a file signature does not exist within an affiliate system, qualitative and quantitative metadata is generated for the file 67 being uploaded and the file and metadata is saved at the host 68. Host system metadata 69 is collated with metadata generated by the host system 68 or an affiliate system 70. A unique URL for a music file and its metadata that can be shared is therefore generated. If a library (uploader) intends to upload more files 71 the process is repeated from step 62. If no more files are to be imported the import is completed 72.

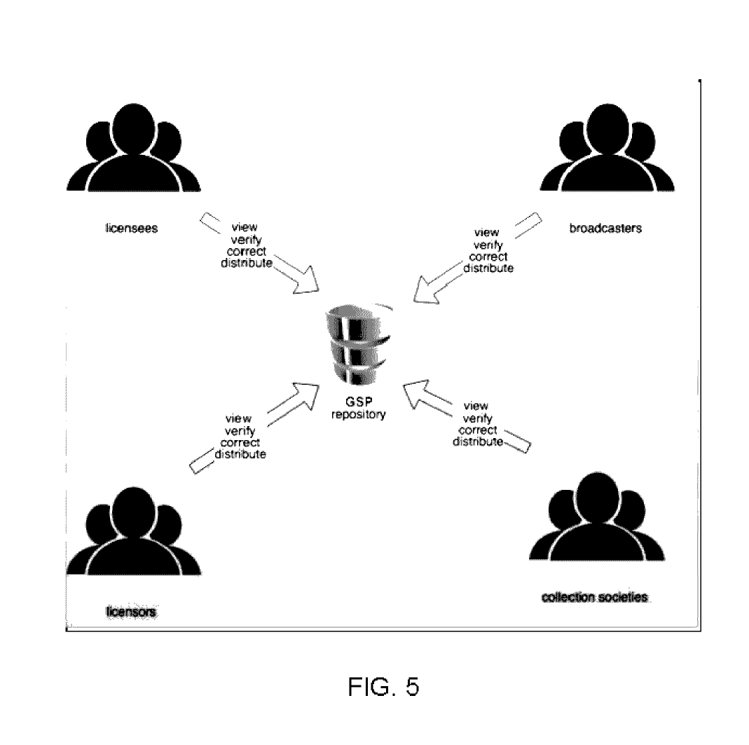

FIG. 5 shows digital cue sheets are stored on a centralised global repository openly available to all related parties; rights owners, production companies, broadcasters and collecting societies. Use of the system therefore guarantees accurate reporting of music identified by a collecting society for use in media productions. It also provides a tool for production companies to precisely log music and manage/complete digital cue sheets. Data can be automatically exported/retrieved by collecting societies and/or broadcasters.

The creation of digital cue sheets (used for collecting performances royalties) enables all parties in a value chain (licensors, licensees, broadcasters and collection societies) to view, verify, correct, and distribute digital cue sheets quickly and efficiently.

The digital cue sheet provides a direct link (URL) to the music file along with all other related metadata. This facility provides a re-licensing facility for both similar reversions of the production (say a cut down version) or the licensing in a completely different non-related production. The unique cue sheet may be served along with the production at broadcast, and thus enables the re-licensing of music used in that production to both business licensors and consumer licensors.

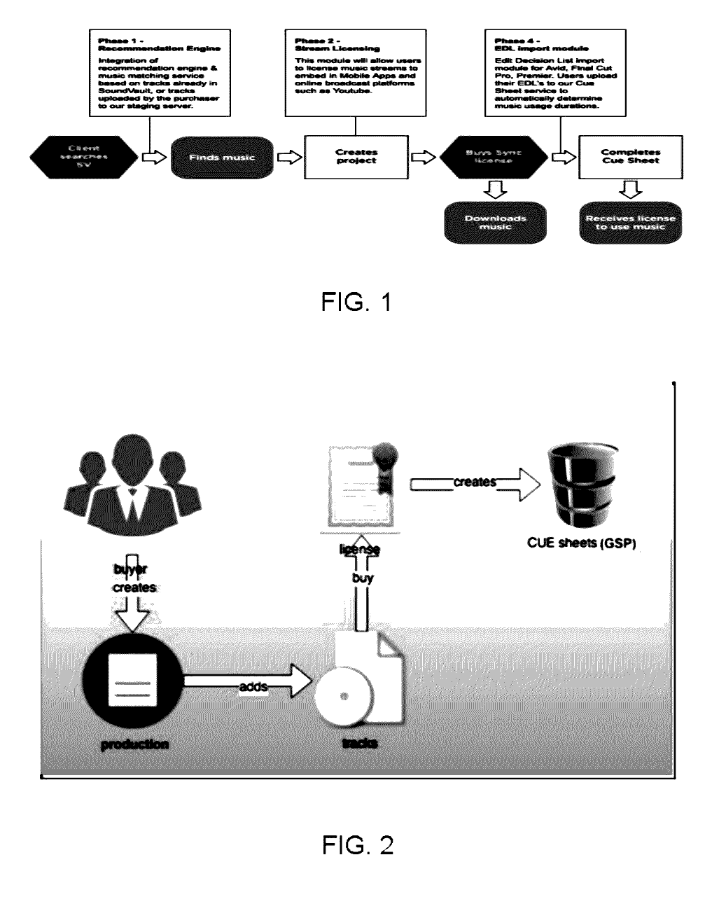

FIGS. 1 and 2 shows overviews of systems that oversee music licensing. The systems enable a buyer to create a production, which allows the buyer to group multiple tracks to be licensed. The buyer adds their desired tracks to the production and licenses them. This creates a cue sheet for that production. The production cue sheet can be reverted into similar production (of varying lengths) and associated cue sheets, providing the licensor with various discounts.

Geo-blocking is an optional technique that is operable by an internet service provider (ISP), carrier or government in the event that certain materials are not to be accessed from, or made available, in a specific territory or jurisdiction.

FIG. 3 shows a more detailed overview of a system that oversees music licensing. The system enables a buyer to create a production which allows the buyer to group multiple tracks to be licensed (step 1).

The buyer then searches for tracks to license (step 2). This step utilises a search algorithm. The buyer adds the desired tracks to the production (step 3) and licenses them (step 4). The license metadata and associated usage rights are added to production (step 5) and automatically imported into the digital cue sheet track selection process (Step 6).

The population of the digital cue sheet is verified by checking a unique digital work identification number which is referred to as a SV-ID which is an acronym for a proprietary ID number. Use of this identification number process prevents two tracks with similar names from being confused and so ensures that the correct recipient (author, composer, performer, record company) receives a payment. This also enables auto creation and verification of the digital cue sheet.

The digital cue sheet is populated with usage data and includes such information as track name, ID and license type (for example advertising, trailer film), license use (for example TV, radio, online) and music use type (for example background, foreground signature music, or credits), duration and location. This information is essential for back-end royalty payments.

Referring to FIG. 3 the system notifies the unique rights owner (step 7). The unique rights owner acknowledges cue sheet entry and is verifies that data relating to the work is correct and complete (step 8), the acknowledgement is stored in the cue sheet database. Currently rights holders have no involvement in this process and do not always know when their music has been licensed. The electronic record will calculate licensing fee and produce a self-billing invoice on behalf of the rights owner. Optional metrics includes process to analyse of how much of music is used and estimate potential performance royalty payments. Music usage may be searched, reviewed and selected using the invention as key statistics and other data are available for each track.

All of these affect the amount of royalty payment to be made. If the rights owner establishes that something in the digital cue sheet is incorrect (e.g. duration or usage), the rights owner/library/publisher may request that the production company/broadcaster makes a correction. The system monitors the process and, after a pre-agreed period (such as 60 days), a third party or overseer is introduced to provide intervention and/or mediation.

If a production company licenses the music and uses it in contravention to the license purchased. The musical rights holders have the ability to report any such violations.

The system may comprise an edit decision list (EDL) importer, which helps pre-populate usage and can include data relating to track name and duration of music used, which is cross referenced against specific identification data for example ownership details and author (steps 6A and 6B).

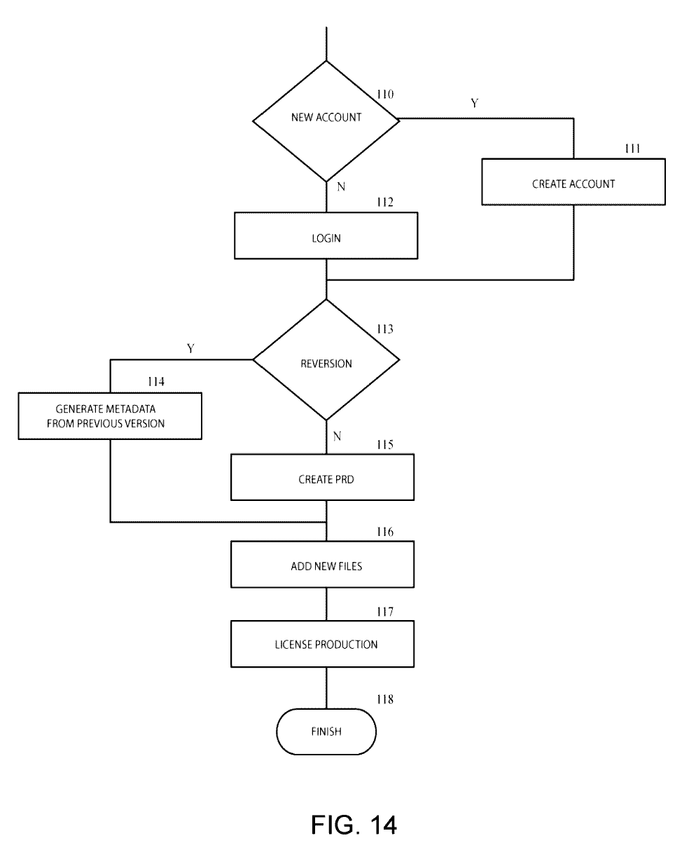

FIG. 14 is a flow diagram illustrating an example of a buyer operating the host system to license files for a new production or reversion an existing completed production and reuse the licensed files for a similar production, (for example a shorter version of the same production). A buyer logs into 112 or creates an account for 111 the system and chooses to create a new create a new production 115 or reversion a production from the cue sheet registry 113. If the user chooses to revert to a previous production, metadata from the previous production is generated and added to new production 114. The buyer then adds new files 116 and licenses the production.

FIG. 12 is a flow diagram illustrating an example of the operation of the host system to create a cue sheet. If the file to be licensed exists 91, the metadata for the file is procured from the database 92. If file is new the system checks if the file ID exists in a third party affiliate system 93. If the file does exist metadata is procured from the affiliate system 95. If the file ID does not exist in an affiliate system, new metadata is generated for the file 94. After metadata has been procured or generated for the file, metadata is provided to the cue sheet 96. User metadata is then added to the cue sheet to complete the entry of file metadata 97. If more files 98 are to be entered, the process starts again from step 91. If no more files are to be registered on the cue sheet, and the library and associated right's owner are notified 99 and the process is completed.

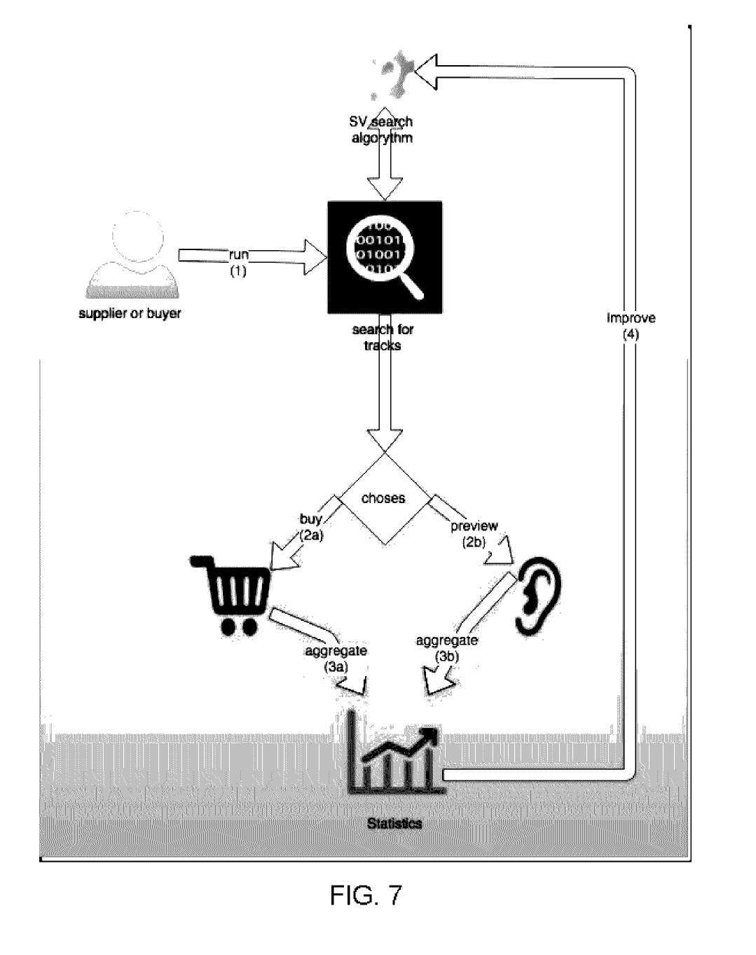

FIG. 7 shows search facilities incorporated in the host system. A user on the host system can run a search on metadata stored on the database (step 1). An algorithm is used to search for file metadata and the result is displayed for user to either buy (step 2a) or preview (step 2b) files on the host system. When either step 2a or 2b are completed the statistics aggregate (steps 3a and 3b) and are used to improve the algorithm (step 4).

Algorithms provide precision results that augment basic meta-data with statistics on popularity, trends in usage and the ability to detect possible musical substitutions. That is, the ability to detect a similar track to one which is popular without infringing copyright.

Ideally “affinity” data is also provided and obtainable for production music tracks and commercial ones. Thus producers are able to select tracks similar to existing styles and so are able to save considerably compared to the cost better known commercial track.

This aspect of the invention is also capable of recommending similarity metrics on either external tracks or tracks and provides a further refinement which enables a keyword based search mechanism to aid music signature based discovery.

The digital cue sheets assist with automatically searching non-music data and how the system improves searching and selection of tracks according to user defined search criteria and/or an enquiry. In addition digital cue sheets are accessible via a laptop, pad, hand-held device or mobile telephone (cellphone).

In all the aforementioned mobile communication devices a playlist is able to be provided to users in a format which is simple to use and browse and which is available to a wide range of users, including: composers, film editors, general public and musicians. This playlist helps users to create and share playlists of music or to explore use in specific scenarios. The playlist assists in creation, aids categorisation and enhances music discovery and recommendation engine.

The system is ideally available on iOS (Trade Mark) and Android (Trade Mark) platforms. It offers a cut down version of the service with music licensing limited to streaming (for example 56 kbps MP3) services. The system is seen as a search and discovery mechanism, enabling libraries to promote their work and users to sample create and share playlists.

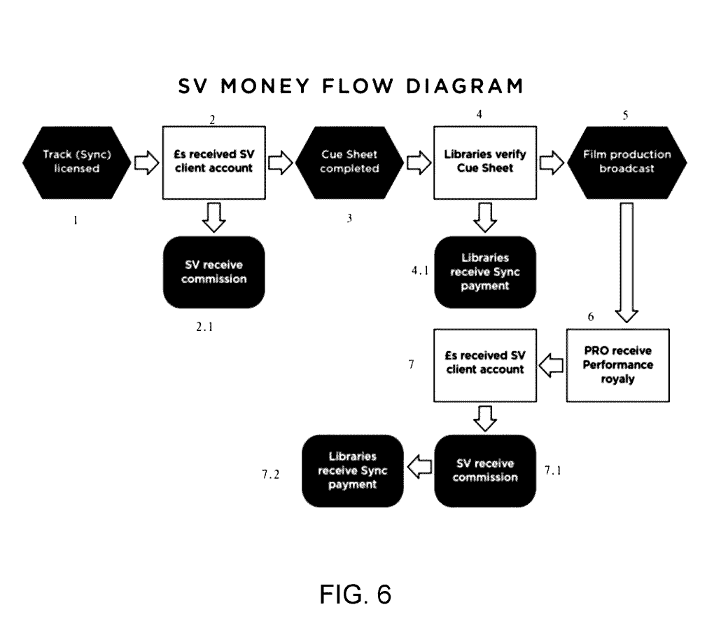

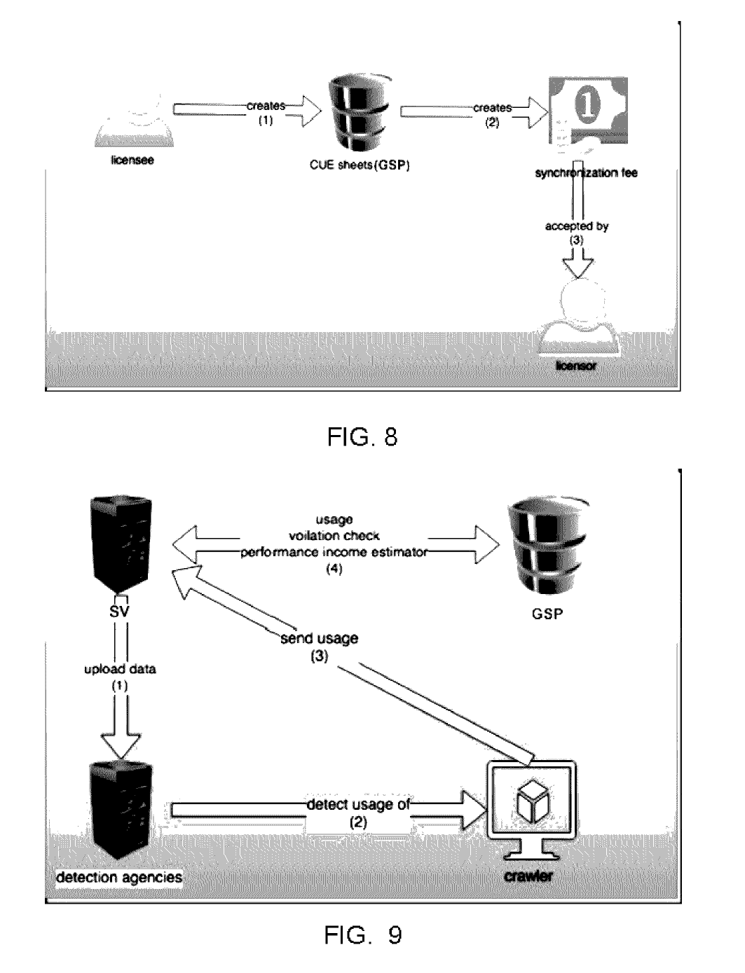

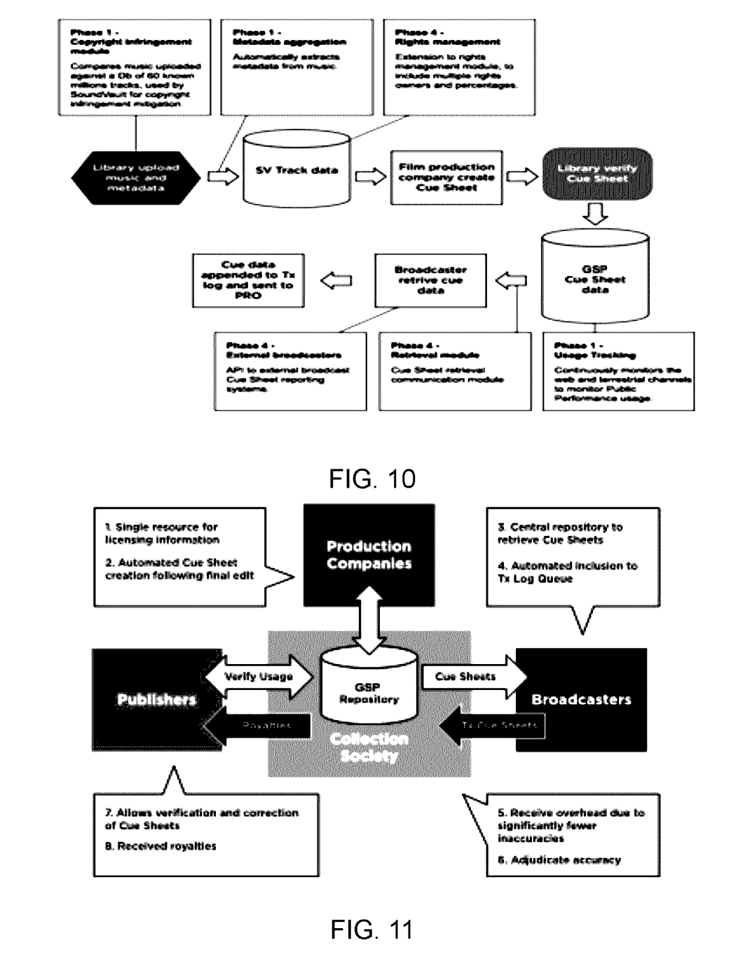

FIGS. 6 and 8 depict payment triggers. At the moment when a digital cue sheet is completed by a licensee, such as a production company, a synchronisation fee is amortised in favour of the rights holder (such as a composer). The composer library or rights owner may then review reported usage and accept the synchronisation fee by acknowledging content of the digital cue sheet. It is appreciated that references to a licensee and licensor are synonymous to seller and buyer respectively.

On acceptance the digital cue sheet makes an auto payment through its self-billing process. Thus the digital cue sheet completion and acknowledgement acts as the payment trigger. This can then be used to analyse how much of the music is used and potential future performance royalties based on public performance. The ability to analyse future income enables a secure assurance, for example for secured loans.

The system may be used to reference different data sources and produces an open digital cue sheet archive of acknowledged, verified and unverified digital cue sheets as a global synchronisation platform (GSP). This enables a broadcaster to collect a digital cue sheet and include it in a transmission log.

This enables digital cue sheet data to be automatically exported from the global synchronization platform (GSP) to a broadcaster's transmission log. The key benefit is that structured data is auto imported instead of relying on a manual import per digital cue sheet, which leads to inaccuracies. This means that if broadcasters use the global synchronization platform (GSP) to source music then they can work directly with the invention which performs royalty computation, tracks payments and fulfils collection.

Digital cue sheets can be integrated with a crawler of transmissions of productions on television, radio and the Internet.

Musical rights owners are then able to be notified in real-time of the usage of their music and so that each party receives an accurate record of what is due to them. Similarly, broadcasters are able to track the fees required to pay for performance royalties.

The notification system also enables musical rights holders to check actual usage of their music in production terms, such as; license type (for example advertising, film), license use (for example TV, radio and online) and music use type (for example background, foreground signature music, or credits) and its actual duration within a production. Users are able to update digital cue sheets and checked and alter them as appropriate. Again producers and broadcasters are party to any such changes as they may affect both synchronisation and performance royalties.

Monitoring services may be built into the invention so that it can conduct ‘web crawling’ in order to seek unauthorised usage. User and usage patterns may also be monitored and suspicious behaviour flagged.

FIG. 9 depicts performance usage tracking. The host system provides metadata of licensed files on its system to detection agencies (step 1) such as the music-usage detection systems BMAT (Trade Mark), SoundExchange (Trade Mark) and TuneSat (Trade Mark). These agencies search for the use of the licensed files, such as through the use of online crawlers (step 2). The results of the searches are sent to the host system (step 3). The host system will then identify registered and non-registered usage (step 4) using the cue sheet database.

Key seller or buyer account holders on the platform have the ability to add, remove and manage other users in their organization and to set permissions directly rather than have to rely purely on centralised administrators. An extension to the music rights management includes multiple rights owners and percentages of royalty that are paid to each interested party.

The invention includes a granulised metadata framework and a unique search functionally. The accuracy of a digital cue sheet ensures this income is maximized with digital tracking to ensure all payments are made to rights-owners.

The invention will include a streamed music licensing purchase system enabling the licensing of low resolution music files to be linked and streamed alongside online broadcast platforms (such as YouTube (Trade Mark) and Vimeo (Trade Mark)) and mobile APPS and games. Licensed music files are of ‘stream quality’ (for example 56 kbps MP3) as opposed to full production quality (320 kbps MP3) as used in television broadcasts. With this particular type of licensing, the music is streamed from the servers and mixed with the visual content rather than being downloaded.

Accurate use of the content is monitored at all times. Further licensing opportunities are available in that music used in one broadcast or programme can be re-licensed directly to another programme without having to visit the website as this licensing can be completed directly via the global synchronization platform (GSP) cue sheet system.

It is understood that the system may be configured in order to be accessible and usable form a mobile communication device, laptop computer, mobile telephone (cellphone), potable tablet or palm held device. In addition to time and date stamping, location specific data may be included in the metadata so that geo-labelling is included in the

So far as third-party providers are concerned, authenticity of data is assured by way of assured third party contacts and licensing terms ensure that from Moodagent (Trade Marks) and TuneSat (Trade Marks).

Data protection is achieved by encrypting personal data so that it is accessed only by appropriate parties. The invention optionally includes a training system to prevent attempts to extract information from unauthorised employees, for example over the phone or via email.

Errors with electronic transactions may also be tracked and monitored so that these can be reported to an industry merchant service provider or compliance department or official.

The present invention therefore enables unique service and licensing tools to be used automatically by parties to an agreement.

Refinement of musical analytical software is able to automate the importation of music metadata process.

It is also understood that the method may include the step of providing a unique digital ID and Internet URL, so as to make all digital cue sheets are retrievable by all licensing parties; production companies, broadcasters, collecting societies, right's owners.

Optionally the method includes the step of providing pro forma royalty calculations based on digital cue sheet licensing data, and live tracking of broadcast channels (digital, terrestrial, online).

Musical works rights management include checking and updating ownership data and royalty sharing arrangements.

Music quality analysis is performed by using search terms in combination with a database of tracks and with discovery and recommendation engine features which search authenticated tracks on the database.

Digital signature recognition enables automatic checking of data, for example in order to identify unlicensed sampling data. In addition digital signature checking assist in creating a unique signature to be registered with ownership details on the system database.

Additionally repository usage and verification of different parties who interact with the system are recorded and stored—so creating an audit trail, as shown in FIGS. 5 and 6.

It will be appreciated that the invention has been described by way of examples only and variation to the aforementioned examples may be made, without departing from the scope of the invention, as defined by the appended claims.

1. A method for providing a unique identifier for a digital work, the work being stored on, and retrievable from, a database, the method includes the steps of: receiving a file of a work in a machine readable format from a subscriber who asserts that the work is an original work; comparing the work with content of third party databases in order to determine whether the work matches any content of a third party database and providing a clearance certificate when no matches are indicated; categorising the work to provide category data in accordance with at least one criterion and incorporating the category data in the form of an indicia, the indicia includes a time and date stamp of receipt of the work from the subscriber; and providing a root identifier which associates the indicia and the clearance certificate with the work so that future use of the work by a third party is monitored in order to report usage to the subscriber and/or rights owner.

2. A method according to claim 1 wherein the work is a digital music file and at least one criterion is selected from the group comprising: tempo, genre, beats per minute (BPM), track name, track duration, composer related data, performer related data, library data and track identification data.

3. A method according to claim 2 includes the step of providing a weighting function is used to assign a weighting to each of two or more criteria that are selected.

4. A method according to claim 1 includes the step of providing a search field in the label for access by a user.

5. A method according to claim 4 wherein search fields are selected from the group comprising: emotion, mood, clarity, texture, motion, type of instrument, soundscape, genres, uses and tempo.

6. A method according to claim 1 includes the step of providing a user specified field wherein a user accesses the database by specifying a search field including: at least one of the following: a user specified subscriber query, a user specified category query, a user specified criterion query, a user specified subscriber query and a user specified rights owner query.

7. A method according to claim 6 includes the step of updating the categorisation index according to user access data and in accordance with an algorithm that reports on usage of search terms.

8. A method according to claim 1 includes the step of providing a digital signature to a subscriber.

9. A method according to claim 1 includes the step of providing a digital cue sheet for the purposes of providing an audit trail of a work.

10. A method according to claim 9 includes the steps of including in the digital cue sheet at least one of the following tag fields: data relating to the rights owner, data relating to an author, the unique identifier, data relating to the subscriber; a label which includes category data and the time and date stamp of receipt of the work from the subscriber, location specific data, the clearance certificate number, the author, the composer, the publisher and the root identifier.

11. A method according to claim 10 includes the step of providing an editable version of the digital cue sheet is populated to include at least the following user specified tag fields: data relating to a user, data relating to a prospective licensee, data relating to an actual licensee, data relating to details of a license or sub-license, data relating to a royalty sharing agreement, data relating to a recipient of a royalty, data relating to an organisation overseeing royalty payments and data relating to a royalty recipient's bank account.

12. A method according to claim 11 includes the step of providing an editable version of the digital cue sheet including at least one of the following user specified tag fields: name and address of the licensor; name and address of the licensee, upload data (time and date); data relating to tracks being licensed and data relating to license usage.

13. A method according to claim 1 includes the step of providing a negotiation platform for enabling a deal to be brokered between at least two of the following: a subscriber, a rights owner, an author, an organisation overseeing royalty payments, a user and a user's agent.

14. A method according to claim 13 includes the step of providing a communication and arbitration platform between two or more licensing parties, enabling rectification of licensing inaccuracies and verification process that are acceptable by all licensing parties.

15. A system provides a unique identifier for a digital work, the system is operative to retrieve the work from, and transmit the work to, a database whereat the work is stored, the system comprises: an input port for receiving a file of the work in a machine readable format from a subscriber who asserts that the work is an original work; a comparator that is operative to compare the work with content of third party databases in order to assess whether the work matches a significant proportion of an existing work stored at a third party database the comparator provides a clearance certificate when no matches are indicated; a categoriser which is operative to categorise the work in order to provide category data in accordance with at least one of a plurality of criteria, the category data including an indicia which affirms a time and date stamp of receipt of the work from the subscriber; and an identifier provides a root identifier which associates both the indicia and the clearance certificate with the work, so that future use of the work by a third party is monitored in order to report usage to the subscriber and/or a rights owner.

16. A system according to claim 15 wherein a means is provided for generating a weighting function to assign a weighting to each of two or more criteria that are selected.

17. A system according to claim 16 wherein the means for generating the weighting function also assigns a weighting factor in accordance with a predefined categorisation index.

18. A system according to claim 15 includes a means for selecting fields from the group comprising: emotion, mood, clarity, texture, motion, type of instrument, soundscape, genres, uses and tempo.

19. A system according to claim 15 includes a means for updating user access data and in accordance with an algorithm reporting on usage of search terms.

20. A system according to claim 15 includes a means for generating an editable cue sheet for the purposes of providing an audit trail of a work.
